(19) United States
(12) Patent Application Publication
(10) Pub. No.: US 2007/0152511 A1
(43) Pub. Date: Jul. 5, 2007

(54) Generating device

(75) Inventors: Yasuhiro Sakai, Tokyo (JP); Junichi Tobe, Tokyo (JP); Eisuke Tsuda, Tokyo (JP); Tamotsu Kato, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: USC CORPORATION, Tokyo (JP)

(21) Appl. No.: 11/645,804

(22) Filed: Dec. 27, 2006

(30) Foreign Application Priority Data
Dec. 28, 2005 (JP) 2005-378112
Jul. 31, 2006 (JP) 2006-207510

(51) Int. Cl. H02N 3/00; H02N 11/00; B60C 23/02; G08B 23/00

(52) U.S. Cl. 310/10; 310/300; 340/693.1; 340/442

(57) ABSTRACT

A generating device to supply electricity to a monitoring device of abnormal state of tire at a lower cost for a long time. The generating device includes a single pendulum 4, a hammer 6 supported at a point S′ on the circumference of a wheel 2, a spring 7 joining the single pendulum 4 and the hammer 6 by soft join, piezoceramics 8a and 8b converting distortion generated by the vibration adding force from the hammer 6 into a form of electricity, and cushion members 9a and 9b holding the positions of the piezoceramics 8a and 8b. A single pendulum 2 has vibrational frequency as same as or of integral multiplication of the rotational frequency of a tire 1.

### BACKGROUND OF THE INVENTION

### Field of the Invention

The present invention relates to a generating device for supplying electricity to a monitoring device of rotational state which monitors abnormal pneumatic pressure of a body of rotation such as a tire.

A monitoring device of abnormal rotation of tire as a body of rotation will be described as an example of the present invention. Since long, a monitoring device of abnormal state of tire has been known that includes a pressure sensor detecting the internal pressure of tire, a temperature sensor detecting the internal temperature of tire and a radio transmitter wirelessly sending the information detected by the pressure sensor and the temperature sensor to a receiver attached to a vehicle body, monitors the abnormal state of the pneumatic pressure of tire, and advises drivers about the abnormal state of the pneumatic pressure of tire when the abnormal state of pneumatic pressure occurred.

In this type of monitoring device of abnormal state of tire, it is designed to supply electricity to electronic devices constituting the monitoring device of abnormal state of tire in such a manner that it utilizes electricity of a battery installed in the interior of tire or the bulb portion and in another manner that a loop coil antenna type power receiving device is installed in the interior or the bulb portion of tire and electricity received by the loop coil antenna type power receiving device from a wireless transmitting and receiving device installed around the tire house is used. For the patent references, there are Patent Kokai (unexamined patent publication) No. 9-136517 as reference 1 and Japanese published unexamined No. 2000-339964 as reference 2.

### SUMMARY OF THE INVENTION

Abnormal state of the pneumatic pressure of tire cannot, however, be monitored for a long time due to the short life of battery when the electricity of battery is used as an electric source for monitoring devices of abnormal state of tire. Moreover, when the electricity received by the loop coil antenna type power receiving device is used as a source of the electricity for monitoring devices of abnormal state of tire, various sorts of constraints may be produced because the distance between the loop coil antenna type power receiving device cannot be extended as well as the cost on the monitoring device of abnormal state of tire increases because a wireless transmitting and receiving device is required to be attached per tire. Technology is proposed for performing a deemed detection of the abnormal state of the pneumatic pressure of tire from the difference between the numbers of rotations of right and left tires by using a sensor for the number of rotation of right and left tires attached to ASB (anti spin brake system) and the like to solve such problem. According to the technology, if the pneumatic pressures of the right and left tires or the four-wheel tires naturally decrease, abnormal state of the pneumatic pressure cannot be detected.

The present invention has been made in view of solving the above problems. An object of the present invention is to provide a generating device which can supply electricity to a monitoring device of rotational state of tire and the like at a lower cost for a long time.

Accordingly, a generating device of the present invention is for supplying electricity to a monitoring device of rotational state that monitors various states such as pressure, temperature and number of rotations generated in a body of rotation, comprising a pendulum installed in the interior of the body of rotation and with vibrational frequency as same as or of integral multiplication of the rotational frequency of the body of rotation, and an electricity generating means for generating electricity produced from the vibration energy by that the pendulum sympathetically vibrates, synchronizes or tunes with rotation of the body of rotation.

Further, a generating device of the present invention is characterized by that a pneumatically adjustable air passage is formed around an arm portion and/or a weight portion of the pendulum.

According to the generating device of the present invention, since electricity can be supplied to the monitoring device of rotational state of tire and the like without using a battery or a loop coil antenna type power receiving device, it can be supplied to the monitoring device of rotational state at a lower cost for a long time.

Furthermore, the generating device of the present invention is constituted in such a manner that a pneumatically adjustable air passage is formed around an arm portion and/or a weight portion of the pendulum. Accordingly, even when the number of rotations of the body of rotation increases and the centrifugal force is enhanced, the vibration amplitude may not decrease. Further, if the number of rotations increases and the vibrational frequency of pendulum rises, mechanical stress may act on the pendulum. To reduce the mechanical stress, configuration of the arm portion and/or the weight portion of the pendulum is formed to moderately receive an air resistance. Hence, restricting the vibration amplitude in vibration at high speed can protect mechanism of the pendulum.

### BRIEF DESCRIPTION OF THE DRAWINGS

FIG. 1 is an explanatory view of a type of speed of acceleration which a point in the interior of a tire receives.

FIG. 2 is an explanatory view of the principle which a rotation of tire and a single pendulum sympathetically vibrate.

FIG. 3 is an explanatory view of the principle which a rotation of tire and a balancing toy type pendulum sympathetically vibrate.

FIG. 4 is a pattern view of the constitution of a generating device in the first embodiment of the present invention.

FIG. 5 is a pattern view of the constitution of a single pendulum in an embodiment of the present invention.

FIG. 6 is a pattern view of the constitution of a balancing toy type pendulum in an embodiment of the present invention.

FIG. 7 is a top view and a side view of constitution of a hammer presented in FIG. 4.

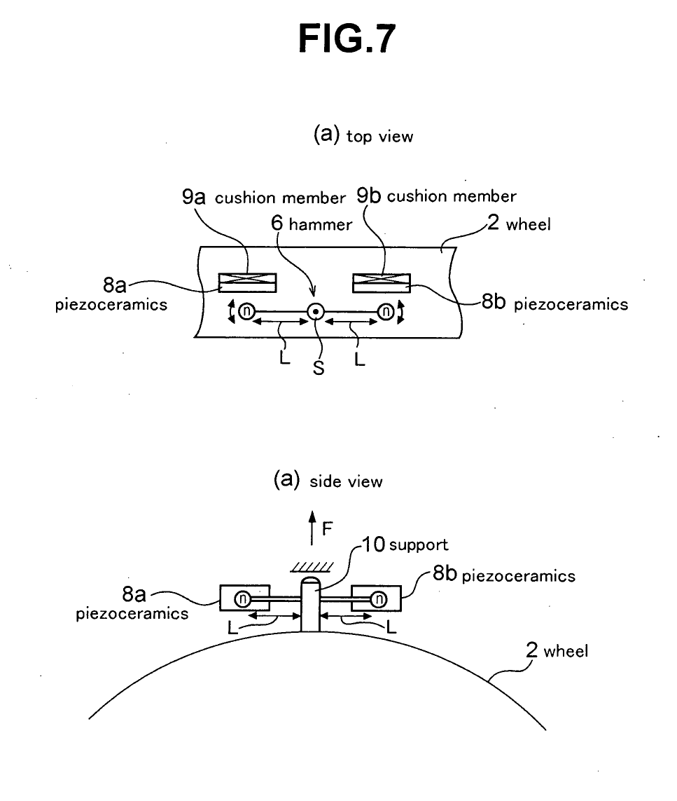

FIG. 8 is a pattern view of constitution of a generating device in the second embodiment of the present invention.

FIG. 9 is a pattern view of a constitution example of the fulcrum portion of pendulum.

### DETAILED DESCRIPTION OF THE PREFERRED EMBODIMENTS

The present invention will be described in further detail by way of example reference to the case in that it is applied to a monitoring device of abnormal rotational state of tire as one of the bodies of rotation. The present invention will also be applied to devices that monitor various states such as pressure, temperature and number of rotations of the bodies of rotation other than tires.

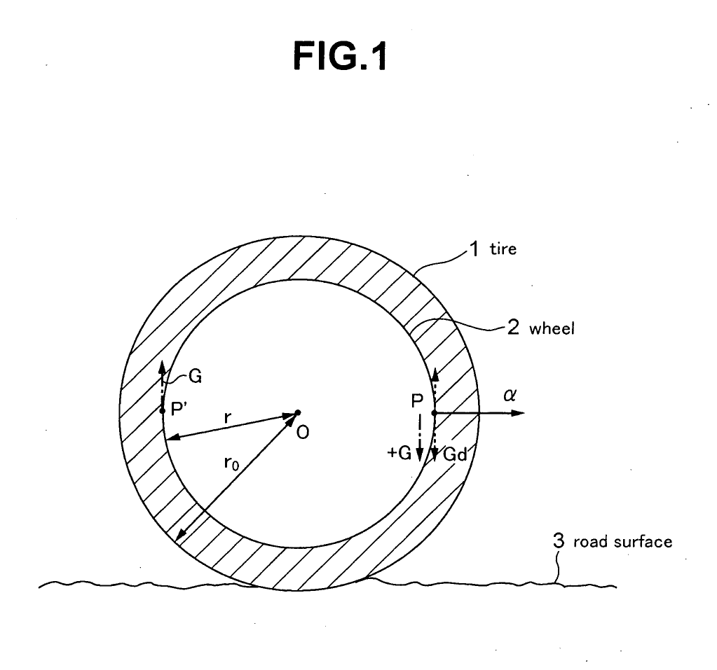

Generally, point P in the interior of tire 1 (which is a point on the circumference of wheel 2 in FIG. 1) receives, as shown in FIG. 1, the speed of acceleration α attributable to the centrifugal force generated with the rotation of tire 1, the speed of acceleration Gd attributable to the suppress strength given by bumpy road 3 and the speed of acceleration G attributable to the speed of acceleration due to earth gravity (9.8 m/s2) which changes the receiving direction in accordance with the rotational direction of tire 1 (the speed of acceleration is +1 G at point P where the direction of the speed of acceleration due to gravity is as same as that of rotations, and −1 G at point P′ where the direction of the speed of acceleration due to gravity is opposite to that of rotations). The speed of acceleration G inevitably makes a change of +/−1 G in the speed of acceleration once per rotation of tire 1.

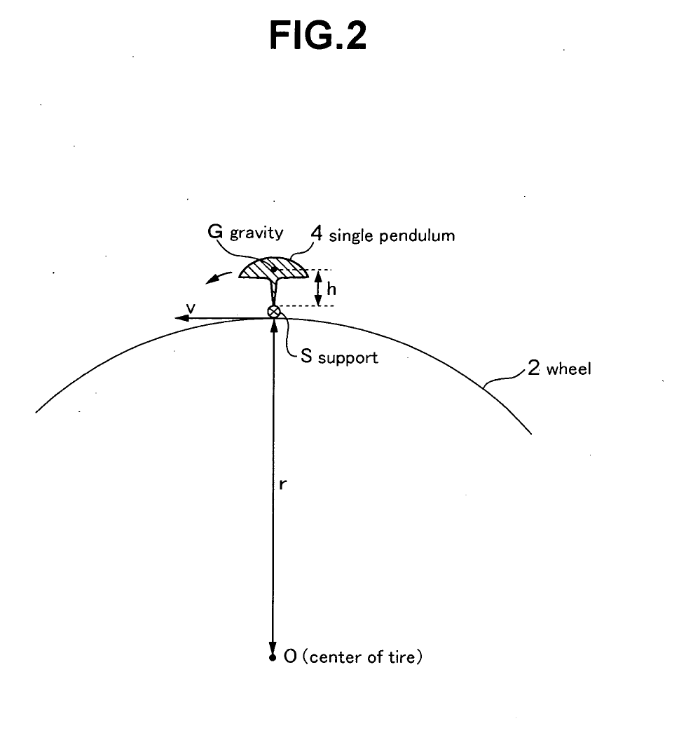

Accordingly, a single pendulum, a balancing toy type pendulum and the like having the vibrational frequency as same as or of integral multiplication of the rotational frequency of tire 1 is placed at point P in the interior of tire 1 so that the rotation of tire 1 and the pendulum can be sympathetically vibrated at any speed of car to produce vibration energy from the pendulum. In particular, when single pendulum 4 is placed on the circumference of wheel 2 as shown in FIG. 2, vibration frequency f0 by change in the speed of acceleration +/−1 G that fulcrum S and weight G of single pendulum 4 receives is presented as shown in mathematical expression 1, wherein parameters v and r are respectively speed of circumference and radius of wheel 2.

$${f}_{0} = \frac{v}{2 π r} \qquad Mathematical Expression 1$$

Moreover, a relation as shown in mathematical expression 2 exists between radius r0 and the speed of external diameter (speed of vehicle) v0 of tire 1. Above-mathematical expression 1 can be changed in following mathematical expression 3.

$$\frac{r}{{r}_{0}} = \frac{v}{{v}_{0}} \qquad Mathematical Expression 2$$

$${f}_{0} = \frac{1}{2 π {r}_{0}} {v}_{0} \qquad Mathematical Expression 3$$

Speed of acceleration α that single pendulum 4 receives from the centrifugal force is expressed in below mathematical expression 4. The specific vibrational frequency f of single pendulum 4 vibration is approximated at infinitesimal by using mathematical expressions 3 and 4 as shown in mathematical expression 5. If the volume of vibration increases, the characteristic frequency of vibration f becomes slightly lower than the data shown in mathematical expression 5.

$$α = \frac{{v}^{2}}{r} \qquad Mathematical Expression 4$$

$$\begin{matrix}f = \frac{1}{2 π} \sqrt{\frac{α}{h}} \\ = \frac{1}{2 π} \sqrt{\frac{{v}^{2}}{h \cdot r}} \\ = \frac{1}{2 π} \sqrt{\frac{1}{h \cdot r} \cdot \frac{{r}^{2}}{{r}_{0}} \cdot {v}_{0}^{2}} \\ = \frac{1}{2 π} \sqrt{\frac{r}{h \cdot {r}_{0}^{2}}} \cdot {v}_{0}\end{matrix} \qquad Mathematical Expression 5$$

Accordingly, vibrational frequency f0 and characteristic frequency f can be sympathetically vibrated at the same frequency by constituting single pendulum 4 with vibrational frequency f0 equivalent to characteristic frequency f. If distance h between fulcrum S and gravity G of single pendulum 4 equals to external diameter r of wheel 2 (h=r) as shown in below mathematical expression 6, the rotation of tire 1 and single pendulum 4 can be sympathetically vibrated without receiving influence by the speed of vehicle v0 and the vibration energy of single pendulum 4 can be produced.

$$\frac{1}{2 π {r}_{0}} \cdot {v}_{0} = \frac{1}{2 π} \sqrt{\frac{r}{h \cdot {r}_{0}^{2}}} \cdot {v}_{0} \qquad Mathematical Expression 6$$

More specifically, the constitution of single pendulum 4 with 5 f0=f is only necessary for sympathetically vibrating single pendulum 4 by five integral multiplications. If distance h between fulcrum S and gravity G of single pendulum 4 and external diameter r of wheel 2 as shown in mathematical expression 7 meet a requirement presented in mathematical expression 8, the rotation of tire 1 and single pendulum 4 can be sympathetically vibrated without receiving influence by the speed of vehicle v0 and the vibration energy of single pendulum 4 can be produced.

$$5 \cdot ( \frac{1}{2 π {r}_{0}} ) \cdot {v}_{0} = \frac{1}{2 π} \sqrt{\frac{r}{h \cdot {r}_{0}^{2}}} \cdot {v}_{0} \qquad Mathematical Expression 7$$

$$h = \frac{1}{25} \cdot r \qquad Mathematical Expression 8$$

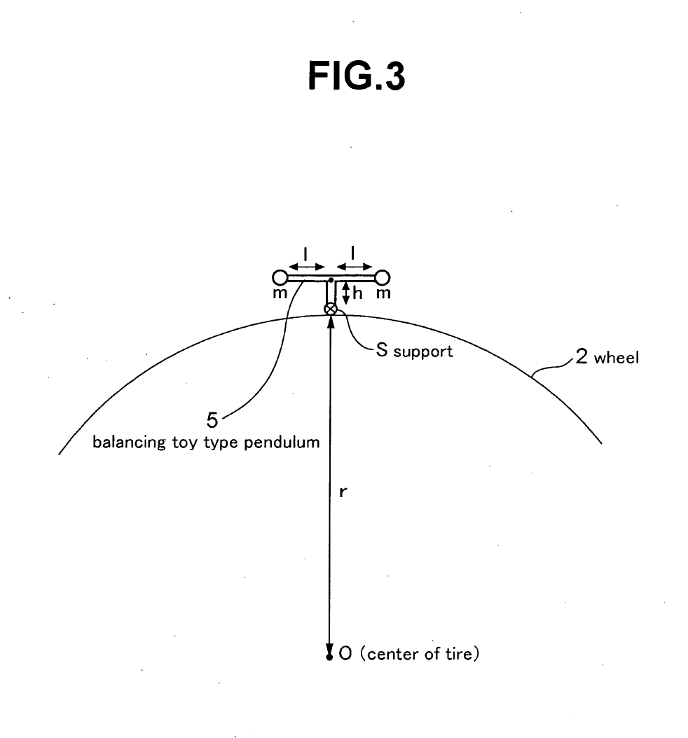

In the above description, single pendulum 4 is used as a pendulum, but the same thing can be also considered in a case of a balancing toy type pendulum. Generally, balancing toy type pendulum 5 is, as shown in FIG. 3, such that a support rod with length l is placed in a horizontal direction to the right and left against the support with height h supported at fulcrum S and a weight with mass m is arranged at the end portion of the support rod. Specific vibrational frequency f of balancing toy type pendulum 5 is expressed at infinitesimal vibration as shown in mathematical expression 9. On the occasion when the volume of vibration increases, characteristic frequency f becomes slightly lower than the data shown in mathematical expression 9.

$$f = \frac{1}{2 π} \sqrt{\frac{α \cdot h}{{l}^{2} + {h}^{2}}} \qquad Mathematical Expression 9$$

h/(l 2+h2) is a characteristic constant dependent on the configuration of balancing toy type single pendulum 5 in above mathematical expression 9. If it is expressed with l/h′, above mathematical expression 9 becomes as shown in mathematical expression 10. Apparently, it is as same as the case of single pendulum 4.

$$f = \frac{1}{2 π} \sqrt{\frac{α}{{h}^{′}}} \qquad Mathematical Expression 10$$

More specifically, the constitution of balancing toy type single pendulum 5 with vibrational frequency f0 equivalent to characteristic frequency f is only necessary for sympathetically vibrating vibrational frequency f0 and characteristic frequency f at the same frequency. If below mathematical expression 11 meets following mathematical expression 12, the rotation of tire 1 and balancing toy type single pendulum $ can be sympathetically vibrated without receiving influence by the speed of vehicle v0 and the vibration energy of balancing toy type single pendulum 5 can be produced.

$$\frac{1}{2 π {r}_{0}} \cdot {v}_{0} = \frac{1}{2 π} \sqrt{\frac{r}{{h}^{′} \cdot {r}_{0}^{2}}} \cdot {v}_{0} \qquad Mathematical Expression 11$$

$$\frac{{l}^{2} + {h}^{2}}{h} = r \qquad Mathematical Expression 12$$

On the occasion when a pendulum is placed on the circumference of wheel 2, it is difficult to raise height h of the pendulum from the viewpoint of the structure of tire 1 so as to adjust characteristic frequency f to vibration frequency f0 and is desirable to set height h on and less than 10 mm. However, in the case of balancing toy type pendulum S, since length l of the support rod has a comparatively tolerable size in view of the structure of tire 1, characteristic frequency f can be reduced by making height h smaller and length l longer. Consequently, taking the structure of tire 1 into consideration, balancing toy type pendulum 5 is desired to be used as a pendulum than single pendulum 2.

A generating device of the present invention will be further described about the structure in the following first and second embodiments according to such technological thinking.

### First Embodiment

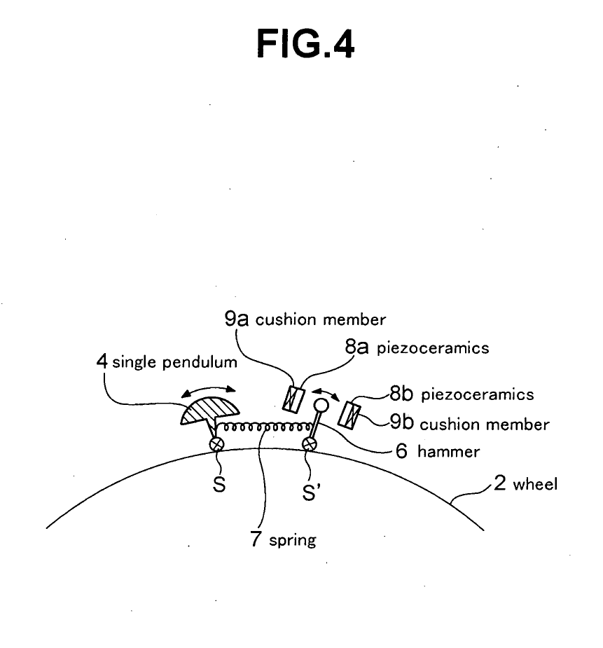

Referring now to FIG. 4, a generating device of the first embodiment of the present invention will be described.

A generating device of the first embodiment of the present invention is placed in the interior of tire 1 and includes single. pendulum 4 supported at point S on the circumference of wheel 2, hammer 6 supported at point S′ on the circumference of wheel 2, spring 7 joining single pendulum 4 and hammer 6 by soft join, piezoceramics 8a and 8b converting the distortion generated by the vibration adding force from hammer 6 into a form of electricity, and cushion members 9a and 9b holding the positions of piezoceramics 8a and 8b. Single pendulum 4 has vibrational frequency as same as or of integral multiplication of the rotational frequency of tire 1. If the pendulum has vibrational frequency as same as or of integral multiplication of the rotational frequency of tire 1, single pendulum 4 may be replaced with other pendulums such as a balancing toy type pendulum.

In a generating device of such configuration, since single pendulum 4 has vibrational frequency as same as or of integral multiplication of the rotational frequency of tire 1, the rotation of tire 1 and single pendulum 4 sympathetically vibrate and the vibration energy of single pendulum 4 is conveyed to hammer 6 via spring 7. After the vibration energy of single pendulum 4 has been conveyed to hammer 6, hammer 6 beats piezoceramics 8a and 8b at every vibration to add vibration adding force. Piezoceramics 8a and 8b convert the distortion generated by the vibration adding force from hammer 6 into a form of electricity, which is then supplied to the monitoring device of abnormal state of tire (not shown).

Accordingly, in such generating device, electricity can be supplied to a monitoring device of abnormal state of tire without using a battery or a loop coil type antenna type power receiving device. Hence, electricity can be supplied to the monitoring device of abnormal state of tire at a lower cost for a long time. In this generating device, single pendulum 4 continues with vibration in response to the energy by the rotation of wheel 2 and a portion of the vibration energy is conveyed to hammer 6 to add vibration to piezoceramics 8a and 8b. Hammer 6 beats piezoceramics 8a and 8b once and then almost stops, and again beats piezoceramics 8a and 8b in the following vibration cycle of single pendulum 4. In other expression, spring 7, joining single pendulum 4 and hammer 6 by soft join, plays a part of cushion between single pendulum 4 that continuously vibrates and hammer 6 that stops after every beat.

Further, in the present embodiment, when radius r of wheel 2 is about 200 mm, sympathetic vibration of five integral multiplications was realized by setting height h of single pendulum 4 at 8 mm. Furthermore, when a balancing toy type pendulum is used instead of single pendulum 4, sympathetic vibration of the same frequency was realized by setting length l of the support rod to 27.6 mm and height h of the support to 4 mm. In this case, vibrational frequency of and characteristic frequency f per the speed of vehicle V0 is expressed as in below table 1.

TABLE 1

| | | f₀ [Hz] | f [Hz] |
|---|---|---|---|
| | | (single pendulum, | (balancing toy |
| speed of vehicle | f₀ | 5 integral | type pendulum) |
| [km/h] | [Hz] | multiplication) | same frequency |
| 15 | 2.1 | 10.5 | 2.1 |
| 30 | 4.2 | 21 | 4.2 |
| 60 | 8.5 | 41 | 8.5 |
| 120 | 17.1 | 85.5 | 17.1 |

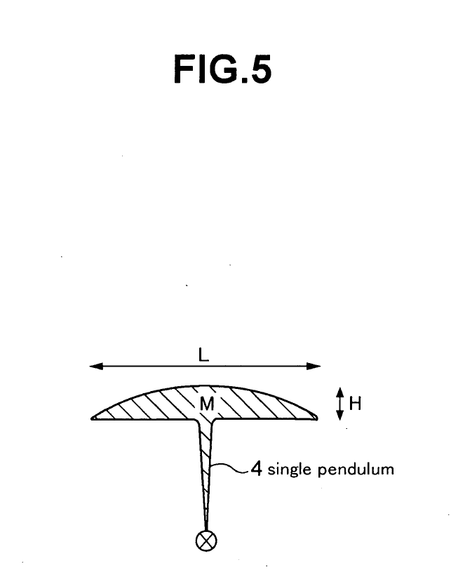

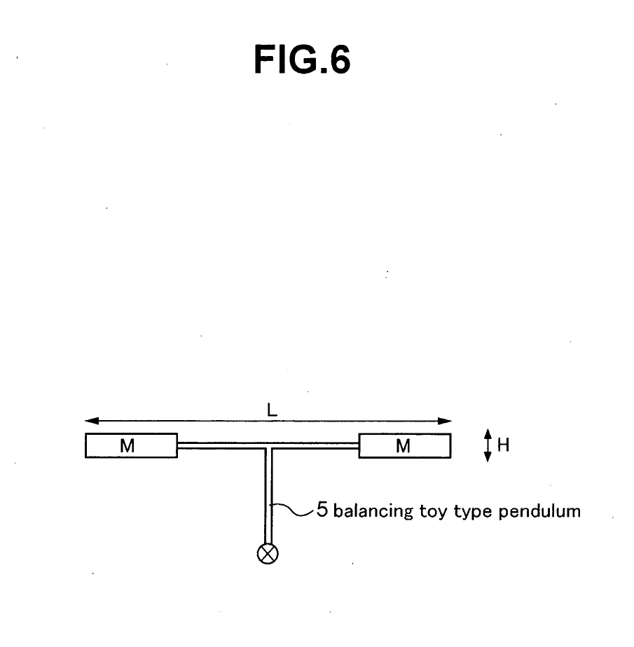

Moreover, as already described, since it is difficult to increase height h of the single pendulum or the balancing toy type pendulum for decreasing characteristic frequency f from the viewpoint of the structure of tire 1, the configuration of single pendulum 4 or balancing toy type pendulum 5 in this embodiment is, as shown in FIGS. 5 and 6, formed in such a manner that length L of weight M is compressed in the direction of height H and length L is expanded in the horizontal direction.

Furthermore, in the present embodiment, for easily vibrating hammer 6 by as much reduction of influence of centrifugal force as possible, the configuration of hammer 6 is formed in such a manner that the support rod with length 2L is supported at center position S (rotating axis) by support 10 and weight n is placed to make the both end portions of the support rod symmetrical. Furthermore, hammer 6 is placed so that the centrifugal force produced by the rotation of tire 1 can vertically move to the rotating axis plane. Accordingly, hammer 6 may have a symmetrical structure against centrifugal force F to take balance against centrifugal force F and to reduce the influence of the centrifugal force. In the present embodiment, the end portion of support 10 is constituted of curved surfaces so as to reduce friction against the support joined to wheel 2.

### Second Embodiment

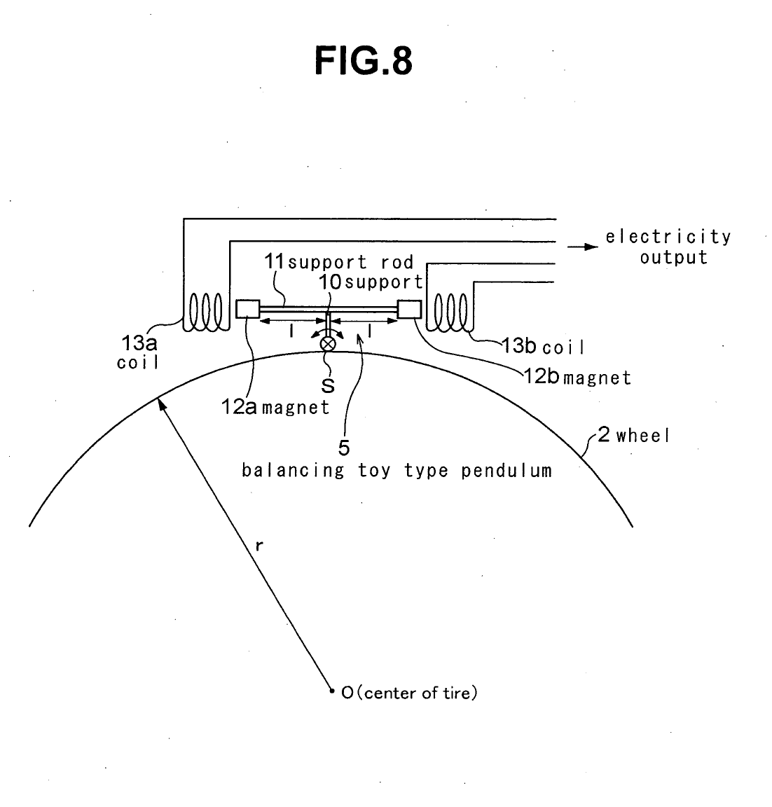

Referring now to FIG. 8, a generating device of the second embodiment of the present invention will be described about the structure.

A generating device of the second embodiment of the present invention is installed in the interior of tire 1, and as shown in FIG. 8, includes balancing toy type pendulum 5 supported at point S on the circumference of wheel 2 and magnets 12a and 12b are placed on the both end portions of support rod 11 which constitute balancing toy type pendulum 5. Further, balancing toy type pendulum 5 has vibrational frequency as same as or of integral multiplication of the rotational frequency of tire 1. Coils 13a and 13b are placed on the position diagonally to magnets 12a and 12b. In addition, in the present embodiment, magnets 12a and 12b are constituted of samarium-cobalt magnet of about three grams and designed to play a part as a weight. Moreover, if radius r of wheel 2 is about 200 mm, height h of support 10 is 4 mm and half-length l of support rod 11 is 27.6 mm.

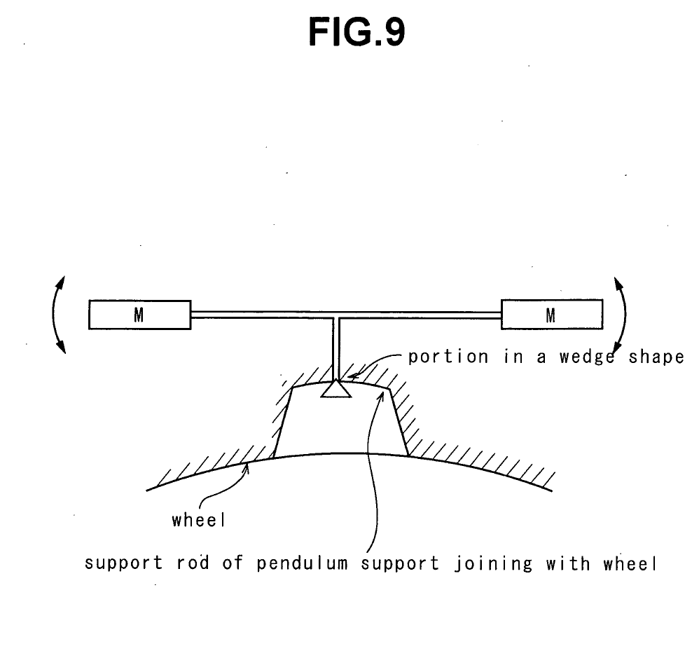

In the generating device of such constitution, balancing toy type pendulum 5 has vibrational frequency as same as or of integral multiplication of the rotational frequency of tire 1, hence the rotation of tire 1 and balancing toy type pendulum 5 sympathetically vibrate at any speed of vehicle v0 and magnets 12a and 12b alternately enter into coils 13a and 13b by vibration of balancing toy type pendulum 5. If magnets 12a and 12b enter into coils 13a and 13b, electricity (induced electromotive force) is induced in coils 13a and 13b. The induced electricity is supplied to the monitoring device of abnormal state of tire which is not shown in the drawings. Subsequently, electricity can be supplied to the monitoring device of the abnormal state of tire without using a battery or a loop coil type antenna type power receiving device and electricity can be supplied to the monitoring device of abnormal state of tire at a lower cost for a long time. If the fulcrum of the pendulum is formed in a wedge shape as shown in FIG. 9, more effective power generation will be performed.

Further, in the generating devices of the respective embodiments, an air passage that can adjust the air resistance is formed around the arm portion and/or the weight portion of the pendulum. For example, the air passage may be a cutout portion, concave chase and the like.

In this manner, the vibration amplitude of the pendulum may not become smaller even when the number of rotations of the body of rotation increases and the centrifugal force increases, but on the occasion when the number of rotations increases and the vibrational frequency of the pendulum increases, mechanical stress may work on the pendulum, but it can be reduced and the configuration of the arm portion and/or the weight portion of the pendulum can be structured to receive the air resistance properly. Hence, the vibration amplitude at the high speed of vibration can be controlled to protect the pendulum system.

Explanation of Codes

1 tire
2 wheel
3 road surface
4 single pendulum
5 balancing toy type pendulum
6 hammer
7 spring
8a, 8b piezoceramic
9a, 9b cushion member
10 support
11 support rod
12a, 12b magnet
13a, 13b coil

1. A generating device for supplying electricity to a monitoring device of rotational state that monitors various states such as pressure, temperature and number of rotations generated in a body of rotation, comprising:
a pendulum, installed in the interior of the body of rotation and having the vibrational frequency as same as or of integral multiplication of the rotational frequency of the body of rotation; and
an electricity generating means for generating electricity produced from the vibration energy by sympathetically vibrating and synchronizing or tuning of the pendulum with rotation of the body of rotation.

2. A generating device according to claim 1, wherein the electricity generating means is a piezoelectric element, converting a distortion produced by addition of the vibration energy, into a form of electricity.

3. A generating device according to claim 1, wherein the electricity generating means generates electricity in such a manner that either of a coil and a magnet is vibrated by the vibration energy to generate induced electromotive force.

4. A generating device according to claim 2, wherein the pendulum vibrates a hammer of giving vibration adding force to the piezoelectric element and the piezoelectric element converts the distortion generated by the vibration adding force from the hammer into a form of energy.

5. A generating device according to claim 4, wherein the pendulum and the hammer are joined by soft join.

6. A generating device according to claim 1, wherein the configuration of a weight of the pendulum is compressed in the vertical direction of size and stretched in the horizontal direction.

7. A generating device according to claim 1, wherein the pendulum is a single pendulum.

8. A generating device according to claim 1, wherein the pendulum is a balancing toy type pendulum.

9. A generating device according to claim 4, wherein a fulcrum of the pendulum is formed in a wedge shape.

10. A generating device according to claim 4, wherein the hammer includes two pieces of weights symmetrically placed from the axis of rotation.

11. A generating device according to claim 4, wherein the hammer is placed such that the centrifugal force generated by rotation of the body of rotation vertically acts on a rotating axis plane of the hammer.

12. A generating device according to claim 1, wherein an air pressure adjustable air passage is formed around an arm portion and/or a weight portion of the pendulum.

13. A generating device according to claim 1, wherein the body of rotation is a tire.

14. A generating device according to claim 2, wherein the configuration of a weight of the pendulum is compressed in the vertical direction of size and stretched in the horizontal direction.

15. A generating device according to claim 2, wherein the pendulum is a single pendulum.

16. A generating device according to claim 2, wherein the pendulum is a balancing toy type pendulum.

17. A generating device according to claim 5, wherein a fulcrum of the pendulum is formed in a wedge shape.

18. A generating device according to claim 5, wherein the hammer includes two pieces of weights symmetrically placed from the axis of rotation.

19. A generating device according to claim 5, wherein the hammer is placed such that the centrifugal force generated by rotation of the body of rotation vertically acts on a rotating axis plane of the hammer.

20. A generating device according to claim 2, wherein an air pressure adjustable air passage is formed around an arm portion and/or a weight portion of the pendulum.
